(19) United States
(12) Patent Application Publication
(10) Pub. No.: US 2026/0187057 A1
(43) Pub. Date: Jul. 2, 2026

(54) Multilinguistic Query Response Agent With Agent Core

(71) Applicant: Oracle International Corporation, Redwood Shores, CA (US)

(72) Inventors: Amit Agarwal, Seattle, WA (US); Tao Sheng, Bellevue, WA (US); Hansa Meghwani, Bengaluru (IN)

(73) Assignee: Oracle International Corporation, Redwood Shores, CA (US)

(21) Appl. No.: 19/004,830

(22) Filed: Dec. 30, 2024

(51) Int. Cl. G06F 16/2452

(52) U.S. Cl. CPC G06F 16/2452

(57) ABSTRACT

Techniques for responding to multilinguistic queries using an agent core are disclosed herein. An agent core is trained and/or fine-tuned in a first language to generate instructions (i.e., commands) for answering a query. A language identification and/or translation model receives queries, identifies languages associated with the queries, and translates the queries to the first language. The agent core generates instructions in the first language based on the translated queries. The instructions include instructions, in the first language, to perform actions such as retrieval, generation, contextual understanding, or calculation, in both the first language and the second language. The results of executing the instructions, including an action performed in the first language and an action performed in one or more second languages, are combined, ranked and/or reranked to generate an answer to the query.

### TECHNICAL FIELD

The present disclosure relates to a language model core for a query response agent system.

### BACKGROUND

Response agents are used in various contexts to answer queries provided by users. Response agents are used as intermediaries between users providing queries to the agent model and other tools or resources used by the agent model to generate an answer. Some tools used by agent models include generative artificial intelligence (AI) models that receive text instruction and generate results from the text instructions. Many models are most suitable with text instruction written in a particular language and are less suitable for queries involving other languages. Queries that are multilinguistic or that do not match the language of a model are not sufficiently answerable using traditional methods.

Techniques in this disclosure may address the aforementioned flaws, challenges, and difficulties by providing techniques that result in improved query response. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example multilinguistic agent response system, in accordance with one or more embodiments;

FIGS. 2A-B illustrate example sets of operations for multilinguistic agent response, in accordance with one or more embodiments;

FIG. 3 illustrates an example multilinguistic agent response to a query, in accordance with one or more embodiments;

FIG. 4 illustrates an example machine learning engine, in accordance with one or more embodiments;

FIG. 5 illustrates example operations for machine learning, in accordance with one or more embodiments; and

FIG. 6 shows a block diagram that illustrates a computer system, in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. EXAMPLE MULTILINGUISTIC AGENT RESPONSE SYSTEM
3. EXAMPLE OPERATIONS FOR MULTILINGUISTIC AGENT RESPONSE
4. EXAMPLE MULTILINGUISTIC AGENT RESPONSE
5. MACHINE LEARNING ARCHITECTURE
6. MACHINE LEARNING OPERATIONS
7. GENERATIVE ARTIFICIAL INTELLIGENCE MODELS
8. COMPUTER NETWORKS AND CLOUD NETWORKS FOR A MULTILINGUISTIC AGENT RESPONSE SYSTEM
9. MICROSERVICE APPLICATIONS FOR MULTILINGUISTIC AGENT RESPONSE SYSTEMS
10. HARDWARE OVERVIEW
11. MISCELLANEOUS; EXTENSIONS

### 1. General Overview

While this General Overview section provides a general overview additional embodiments and related combinations of features may be described in this Specification and/or recited in the claims outside of this General Overview section.

Due to the concentration of research and development in large language models (LLMs) being concentrated in English, a significant disparity exists between the capabilities of English LLMs and other language LLMs. This imbalance restricts the applicability and utility of LLMs in multilingual contexts. Smaller language models often lack the robust reasoning and action planning capabilities needed to manage multilingual queries, particularly when tasks involve API calls, complex processes, coordination, and/or planning. The gap in traditional retrieval augmented generation (RAG) capabilities across LLMs of multiple languages due to the imbalance of data between the multiple languages limits the ability of such traditional systems to provide consistent and high-quality responses across the multiple languages.

In embodiments, the multilingual response agent system disclosed herein provides a method for integrating multilingual capabilities to manage multilingual queries. In embodiments, the system integrates multilingual capabilities into an existing English-based RAG system by using a language detection and/or translation service, a relatively smaller finetuned English agent core, a retrieval and ranking module, and a relatively larger generative model for both English and multilingual response generation. For example, if a user asks a question in Japanese, the system searches a knowledge base or other database for both Japanese and English documents for the given query and uses the documents or other retrieved augmentations to improve the generated response. This approach ensures streamlined prompt management, high performance, scalability, and usability of the agent system across multiple languages.

### 2. Example Multilinguistic Agent Response System

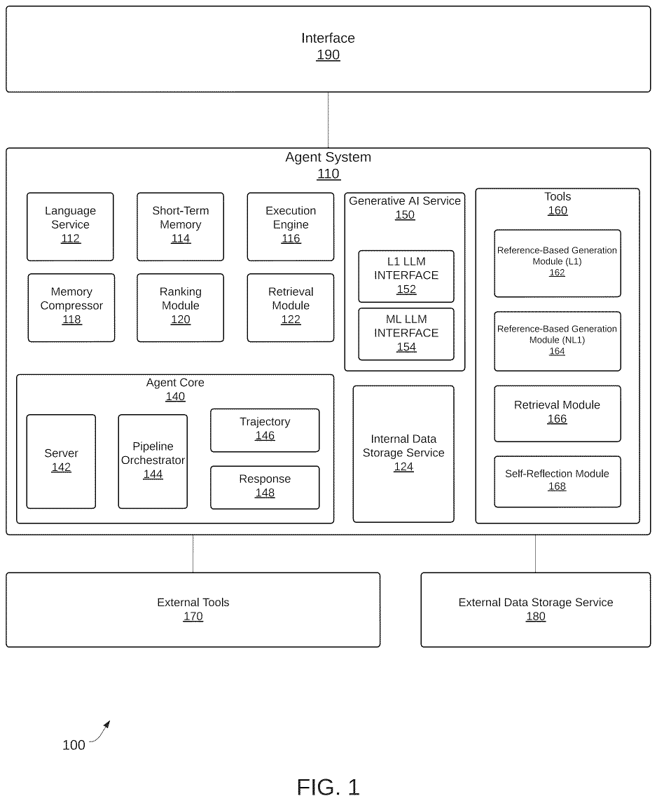

FIG. 1 illustrates an example multilinguistic agent response system 100. In various embodiments, the system 100 may include more or fewer components than the components illustrated in FIG. 1. In various embodiments, the components illustrated in FIG. 1 are local to or remote from each other. The components illustrated in FIG. 1 are implemented in software and/or hardware. The components are distributed over multiple applications and/or machines. Multiple components may be combined into one application and/or machine. Operations described with respect to one component may instead be performed by another component.

In FIG. 1, the system 100 includes an agent system 110, external tools 170, an external data storage service 180, and an interface 190. In the example, the agent system 110 includes a language service 112, short term memory 114, an execution engine 116, a memory compressor 118, a ranking module 120, a retrieval module 122, an internal data storage service 124, an agent core 140, a generative AI service 150, and one or more tools 160.

In the example of FIG. 1, the language service 112 includes components and models responsible for handling linguistic inputs by identifying languages used in the inputs and/or translating inputs from one language to another. In embodiments, the language service 112 includes a language identification model and/or one or more language translation models. The language service 112 identifies a language associated with a query and/or translates the query or portions of the query from an identified language to another language. For example, the language translation model translates the query from one or more second languages to a first language different from the one or more second languages.

In embodiments, the language service 112 consists of language models, natural language processing algorithms, and/or syntax parsing mechanisms. The language models are neural networks that have been trained on large datasets of human language, while the natural language processing algorithms include entity recognition, language understanding, and sentence segmentation functionalities. The syntax parsing mechanisms are structures that break down language into its grammatical components, ensuring that the language service 112 identifies languages and/or translates queries correctly.

In some embodiments, the language service 112 comprises a language detection and/or translation model. In embodiments, the language detection and/or translation model, or another specialized language determination model, runs on one or more central processing units (CPUs). In embodiments, the language service 112 performs language detection and/or translation using a specialized language determination model that operations entirely on central processing units (CPUs), which are less resource intensive and less costly to operate than graphics processing units (GPUs).

The short-term memory 114 is a temporary storage component within the agent system 110. The short-term memory 114 is composed of volatile memory units, such as dynamic random-access memory (DRAM) or other memory, and is designed to store data relevant to the immediate execution of tasks. The short-term memory 114 is linked to caching systems that hold transient information, which can be rapidly accessed and replaced as the system processes incoming actions or queries.

The execution engine 116 is a processing unit responsible for running instructions within the agent system 110. For example, the execution engine 116 is composed of a compiler, an interpreter, and a runtime environment. The compiler transforms high-level code into machine-level instructions, while the interpreter allows for the execution of code in languages that do not require compilation. The runtime environment within the execution engine 116 includes resource management components, error-handling mechanisms, and the like.

The memory compressor 118 is a data optimization component within the agent system 110. The memory compressor 118 consists of algorithms for reducing the size of stored data and includes both lossless and lossy compression techniques. The memory compressor 118 ensures that data storage uses encoding and decoding mechanisms to compress and/or decompress the data.

The ranking module 120 includes modules for data evaluation, ordering, ranking and/or reranking. The ranking module 120 is composed of scoring algorithms, comparison metrics, and prioritization logic. The scoring algorithms assign numerical values to items or actions based on predefined criteria, while the comparison metrics provide a means to assess the relative importance of different items. The prioritization logic within the ranking module 120 determines the order in which items or actions are processed, based on their evaluated importance. In embodiments, the ranking module 120 includes specific rules for ranking, reranking, and/or evaluating answer content and/or responses content generated by the response agent and/or internal or external tools or modules. In embodiments, the ranking module 120 includes metrics for evaluating or ranking portions of retrieved documents that are in different languages.

The retrieval module 122 is a data acquisition component within the agent system 110. The retrieval module 122 includes components for executing instructions generated by the agent system that involve accessing and/or transferring data from one or more data sources. For example, the retrieval module 122 consists of query processing algorithms, indexing structures, and data connectors. For queries for which the agent generates instructions requiring retrieval of data, the indexing structures facilitate the retrieval module 122 accessing data stored in databases or other repositories. The data connectors link the retrieval module 122 to external systems.

The internal data storage service 124 is a repository for storing persistent data within the agent system 110. The internal data storage service 124 is composed of databases, file systems, and data management protocols. For example, one or more databases store structured data in tables or similar formats, and/or one or more file systems store unstructured data such as text files, images, or logs.

The agent core 140 is a central coordinating unit of the agent system 110. The agent core 140 includes a server 142, a pipeline orchestrator 144, trajectories 146, and responses 148. In various embodiments, the agent core 140 comprises a language model that is fine tuned in a first language and/or which has no more than approximately seven billion (7 B) to ten billion (10 B) parameters.

The server 142 is the physical or virtual infrastructure that hosts the computational components of the agent core 140. For example, a hypertext transfer protocol (http) server is suitable for hosting an agent core as an agent core server.

The pipeline orchestrator 144 comprises modules that determine a series of processes that move data or tasks through the agent system 110 in a structured manner. The pipeline orchestrator 144 orchestrates an agent loop pipeline by determining sequences of actions based on a query and/or the results of one or more intermediary actions taken to answer the query. The pipeline orchestrator 144 determines the sequence of steps needed to answer a query. In some cases, the result of a step is provided to the agent loop orchestrator to determine a subsequent step in what is referred to as an agent loop or trajectory. In various embodiments, the orchestrator 144 is fine-tuned in a first language. The pipeline orchestrator 144 receives information and generates instructions in the first language describing actions to be taken to answer the query.

The trajectory 146 is the sequence of decisions and actions that the agent system 110 follows in response to a query. The response 148 is the final output produced by the agent system 110 after processing a query. In various embodiments, the response is generated by parsing and/or recombining information from one or more sources. Example information sources include documents retrieved from a database, output received from a model, the result of a calculation, operation, or function, or other augmentation. In embodiments, one or more augmentation databases are maintained that index documents or data sources for augmenting the query. The retrieval module 122 may search through the pre-indexed documents or data sources with an augmentation database to retrieve information that is relevant to the query. The augmentation information may serve as a factual foundation or supplement to enhance query result accuracy.

The generative artificial intelligence service 150 is a component responsible for communicating with the agent core 140 and one or more generative AI models to create generative AI output based on a prompt and/or instructions generated by the agent core 140. In the example, the generative artificial intelligence service 150 is composed of interfaces for accessing deep learning models, training data, contextual data, and/or neural network architectures. In general, the agent core 140 of embodiments is one or more orders of magnitude smaller, in terms of the number of parameters, as a multilinguistic large language model.

In the example, the generative AI service 150 includes a first language large language model interface 152 and a multilingual large language model interface 154. The first language large language model interface 152 enables communication with one or more large language models for a single language, one or more models for a first language and/or one or more other languages. The multilinguistic large language model interface 154 enables communication with one or more multilinguistic generative models, such as Cohere R+, Mistral Large 2, or LLaMa3.1, each of which have at least approximately one hundred billion (100 B) parameters.

The tools 160 are a collection of services and modules that support the agent 110. The tools 160 include a reference-based generation module 162 for the first language, a reference-based generation module 164 for languages other than the first language, a retrieval module 166 and a self-reflection module 168.

The reference-based generation module 162 for the first language includes models that generate output in the first language based on input references in the first language (and/or other languages in some cases). The reference-based generation module 162 generates content based on the referenced information in the first language.

The reference-based generation module for languages other than the first language includes models that generate output in a particular language based on input references in the one or more other languages (and/or the first language in some cases). The reference-based generation module 164 generates content based on the referenced information in the one or more other languages.

The retrieval module 166 is composed of data acquisition components similar to the retrieval module 122 and consists of query processing and indexing functionalities. The self-reflection module 168 is composed of evaluation algorithms and feedback systems, enabling the agent core 140 to assess the performance of a pipeline orchestration and/or to determine a next action. The feedback systems allow the self-reflection module 168 to collect data on the effectiveness of actions taken, while the evaluation algorithms use this data to improve future performance.

The external tools 170 include one or more applications, models, and/or systems accessible by the agent system 110, such as various public domain generative AI models accessible via application programming interfaces (APIs), web-based applications, and the like.

Generally, the external data storage service 180 stores data loaded onto agent 110 and/or external tools 170. The external data storage service 180 optionally stores data loaded from other sources. In various embodiments, the external data storage service stores one or more types of data including, but not limited to, document data, query data, response data, source data, user data, asset data, etc.

In an embodiment, the agent 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (“NAT”), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In one or more embodiments, the interface 190 refers to hardware and/or software configured to facilitate communication between a user and a system. In FIG. 1, an interface 190 is used to facilitate communication between the agent system 110, and/or one or more client computing devices. Such an interface 190 renders user interface elements and receives input via user interface elements. Examples of interfaces include a graphical user interface (“GUI”), a command line interface (“CLI”), a haptic interface, and a voice command interface. Examples of user interface elements include checkboxes, radio buttons, dropdown lists, list boxes, buttons, toggles, text fields, date and time selectors, command lines, sliders, pages, and forms. In various embodiments, different components of such an interface are specified in different languages. The behavior of user interface elements is specified in a dynamic programming language such as JavaScript. The content of user interface elements is specified in a markup language, such as hypertext markup language (“HTML”) or extensible markup language (“XML”) User Interface Language (“XUL”). The layout of user interface elements is specified in a style sheet language such as Cascading Style Sheets (“CSS”). Alternatively, interfaces may be specified in one or more other languages, such as Java, C, or C++.

### 3. Example Operations for Multilinguistic Agent Response

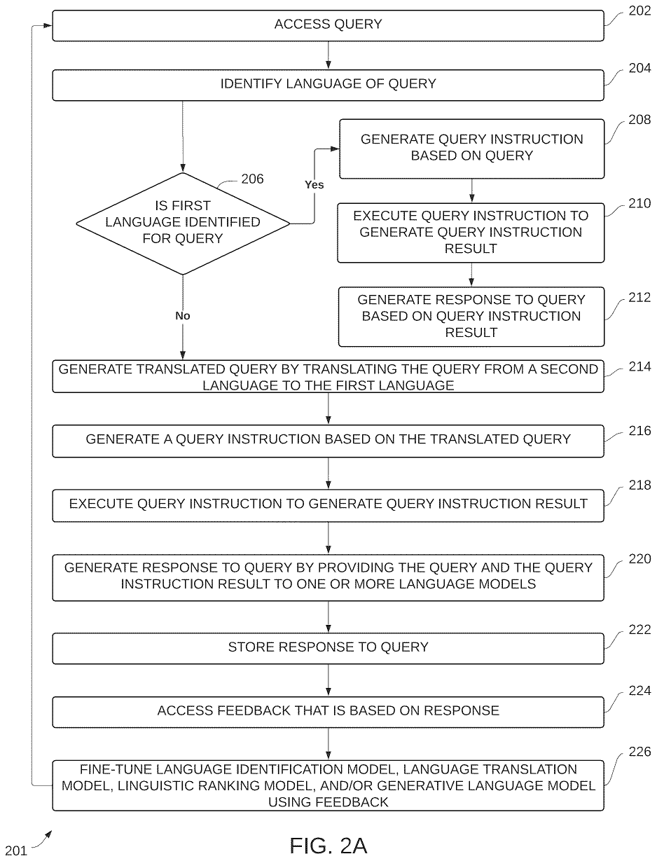

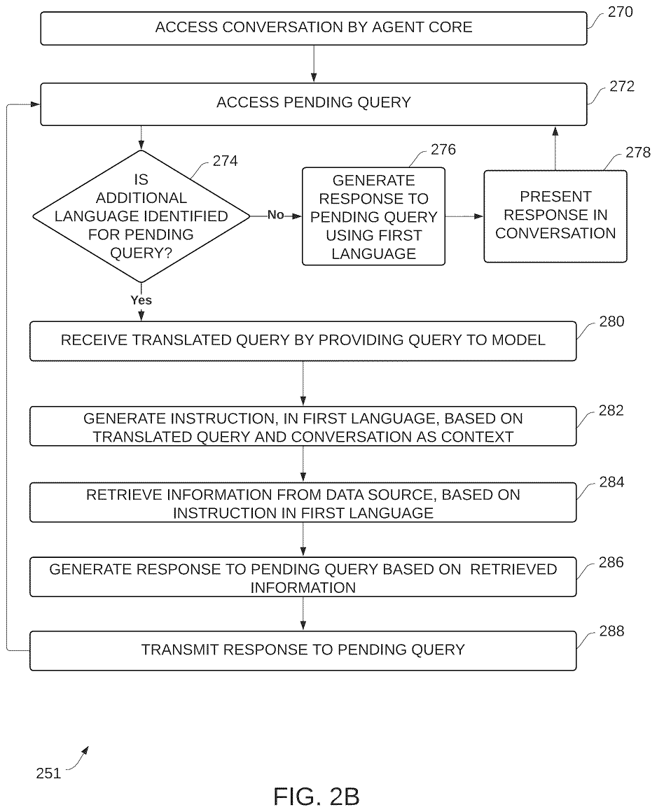

One or more operations illustrated in FIGS. 2A-B may be modified, rearranged, or omitted. Accordingly, the particular sequence of operations illustrated in FIGS. 2A-B should not be construed as limiting the scope of one or more embodiments. FIG. 2A illustrates an example set of operations 201 in accordance with one or more embodiments.

In the example, the system accesses a query (Operation 202). The system retrieves a query from a source such as an external user or an internal process. For example, the system accesses a query that has been entered into a client device via an interface.

The system identifies a language of the query (Operation 204). The system analyzes the content of the query to determine the language used and/or to assign one or more language codes (representing a language) to the query. This process involves providing the query to a machine learning model that is configured for language identification and/or comparing the query to a set of known language templates. In embodiments, a language detection model is trained and fine-tuned to perform language detection on input queries. The system runs the query through language identification models which use algorithms designed to detect the language, producing a result identifying which language or languages the query includes or requires to answer. In some embodiments, the language identification model is trained to detect language referenced by the query. For example, the language detection model detects a second language for a query based on the query requesting an analysis of a document in the second language. In various embodiments, a document is known to be in the second language (e.g., via a label or metadata) or is identified by the language identification model to be in the second language.

The system determines if a first language is identified for the query (Operation 206). The system verifies whether the language identification from Operation 204 produced a result identifying the first language. In some cases, particular tools and/or a particular knowledge base exist for a particular language, and this language is considered the first language. For example, a particular large language model has the largest percentage of its vocabulary in English, so English is determined to be the first language for the particular large language model based on having the largest vocabulary size. In other embodiments, another language is considered as a first language.

If the query is in a first language, the system generates a query instruction based on the query (Operation 208). The system ingests the query and generates a set of executable instructions or commands based on the query. An agent core receives the query and determines one or more thoughts, actions, and/or observations associated with the query. The agent core generates a trajectory according to the thought, action, and/or observation and generates a set of one or more executable instructions or commands for completing the trajectory. In embodiments, the data associated with the query, the executable instructions, and with the thoughts, actions, and/or observations are stored in a short-term memory of the agent core.

In an example embodiment, the system generates a query instruction by analyzing the initial query and converting it into a structured trajectory of steps taken to produce a comprehensive response using available resources. In an example, the system begins by parsing the query to extract key elements and constraints. The system evaluates these elements to identify what data needs to be retrieved or generated. The initial phase of trajectory generation includes defining the primary operations to gather necessary information from external sources or internal knowledge. These operations involve searching databases, applying language models for completion, identifying relevant reference materials, and/or the like. Once the data is gathered, the system defines the next steps to synthesize this information into a structured response.

The system generates thoughts by maintaining a dynamic memory of the ongoing operations and their intermediate results. In an example, while the system is executing a search for external data, the system generates intermediate observations about the relevance or irrelevance of the data being retrieved. These thoughts serve as checkpoints, refining the query's scope or adjusting future actions based on the success or failure of previous operations. The system updates its internal reasoning to decide whether additional data is required and/or useful, or if the current data is sufficient and/or complete. These thoughts provide a feedback mechanism that informs the system's future steps, ensuring that the trajectory remains aligned with the query's needs.

Observations made by the system result from the continuous monitoring of actions and their outcomes during the execution of the query instruction. In an example, as the system retrieves external documents, the system generates observations about the content, such as whether it matches the query's subject matter or if further refinement is needed. The system compares these observations against the query's original parameters, determining if the trajectory should continue along its current path or if a course correction is necessary. Observations facilitate managing the flow of operations, allowing the system to pause, refine, or continue executing the steps to answer the query.

The system executes the query instruction to generate a query instruction result (Operation 210). The system processes the previously generated instructions by executing them in a computing environment or sending the instructions as input prompts to one or more generative AI services (or to another model or tool). The execution of the instruction involves tasks such as retrieving relevant data, performing calculations, sending requests to external tools, generating content based on a prompt, and/or the like. The output from this execution generates a result that corresponds to the instructions generated for the query.

The system generates a response to the query based on the query instruction result (Operation 212). The system creates a response by utilizing the results obtained from executing the query instructions in Operation 210. This process involves analyzing the query instruction result and formatting the relevant information into a coherent and structured response. In embodiments, the system incorporates various elements such as text, data points, or summaries derived from the execution output.

If the system determines that a language other than the first language is identified for the query, the system generates a translated query by translating the query from a second language to the first language (Operation 214). In various embodiments, the system employs one or more language translation models. For example, the system utilizes a translation model that includes a bilingual corpus for the first language and the second language. In embodiments, a plurality of machine learning models are trained on datasets including information in the first language and information in one or more second languages. In some embodiments, the translation model is fine-tuned using feedback for answers generated by an agent system using the translation model, the feedback indicating whether the answer was valid and/or the language translation was successful.

In some embodiments, the system determines if multiple languages are identified for the query. The system analyzes the input query to identify any languages present within the text using a language detection model. For example, the language detection model employs various detection algorithms to classify segments of the query into one or more language categories indicating one or more languages, thereby establishing whether the query consists of content in more than one language. The system generates a translated query by translating the query to a first language from one or more second languages. For instance, if the initial query is in Spanish or French and documents identified for answering the query are in both Spanish and French, the system generates translated versions of the both the Spanish and French portions of the query in English using a translation model (or using two separate bilingual translation models for Spanish and English and for French and English).

In some embodiments, the system generates a translated query by translating the query to a first language from one or more second languages. The system accesses one or more bilingual or multilingual translation models, services, or algorithms to translate the query. For instance, if the initial query is in Spanish or French and documents identified for answering the query are in both Spanish and French, the system generates translated versions of both the Spanish and French portions of the query in English using a translation model (or using two separate bilingual translation models for Spanish and English and for French and English). In some embodiments, in addition to or instead of generating the translated query, the query is provided to a second agent core that has been trained and/or fine tuned in the second language (instead of a first agent core for the first language) if the language identification model determines that the query is written in the second language.

The system generates a query instruction based on the translated query (Operation 216). In embodiments, an agent core ingests the translated query, performs reasoning and action planning, and generates a set of instructions in the first language based on the translated query. For example, the agent core receives the translated query and determines a thought, action, and/or observation in the first language. The agent core generates a trajectory for answering the query according to the thought, action, and/or observation and generates a set of one or more executable instructions for completing the trajectory.

The system executes the query instruction to generate a query instruction result (Operation 218). In embodiments, this operation entails sending the instruction to an execution engine, which performs the defined actions using various tools. The execution engine processes the instruction by interfacing with relevant databases or services of the tools to retrieve or compute the supporting data. An example of this operation is using a database tool to query a database for information which forms the translated query instruction result. For example, a retrieval module may search through pre-indexed documents or data sources within one or more augmentation databases for supporting data that is relevant to the query. The retrieval model may be based on techniques such as TF-IDF (Term Frequency-Inverse Document Frequency) or more advanced techniques like dense vector search using word embeddings. In an embedding model, the documents in an augmentation database may be converted into embeddings, which are high-dimensional vector representations of the text. The retrieval model may then find the documents whose embeddings are closest to the keyword embeddings extracted from the query using a similarity metric like cosine similarity. Other examples for obtaining augmentation data include tasks such as performing calculations, generating content based on a prompt, sending requests to other external tools, and/or the like.

In embodiments, the system provides the initial query and/or a language code for the initial query to a tool (e.g., a retrieval and/or ranking tool) as part of the translated query instruction in addition to or instead of the providing the translated query. In embodiments where an instruction includes queries in different languages, the system receives a plurality of results for the different languages. In embodiments, an instruction includes a context in the first language, a prompt in the first language, and/or one or more queries in the first language and/or one or more different languages.

The system ranks the plurality of query instruction results. The system evaluates the results generated from the executed query instructions to establish a ranking order based on predetermined criteria, such as relevance or accuracy. The system applies algorithms that assess various factors, including the quality of the responses and their alignment with the original query intent. For example, if one result provides a more comprehensive answer than others, it receives a higher rank in the final output. In embodiments, results for a particular language are ranked to generate a result for that language. In embodiments, results for multiple languages are compared and ranked to generate an answer. In some embodiments, information in one or more languages is weighted based on the language of the information corresponding to a language for the answer, based on being a first language or primary language, or based on some other criteria.

In embodiments, the rankings are used to identify which augmentation data to retrieve for a given query. For example, the retrieval module may retrieve the highest ranked document or the top n highest ranked documents to augment a query. The retrieved information serves as a factual foundation or supplement to the original or translated query. An LLM may generate a response based on both its own knowledge from pre-training and the retrieved information. The augmentation information may originate from specific, authoritative sources, in one or more languages, which increases the likelihood that the answer is more accurate, contextually relevant, and up to date.

The system generates a response to the query by providing the query and the translated query instruction result to one or more language models. (Operation 220). In various embodiments, language models are large language models for the first language, for the second language, and/or for more than one language (i.e., a multi-lingual large language model). In embodiments, an intended output language is determined for the user query. The original query and the query instruction result are submitted to a language model capable of understanding and generating text output in a language matching the intended output language for the query. For example, a second language of a query different from a first language used by an agent core for reasoning is an intended output language by default in the case that the translated query is a translation of the query from the second language to the first language. For example, the original query may include keywords and phrases in a second language, which is the intended output language by default. Per Operation 214, the query is translated into a first language that is used by an agent core for reasoning. In this scenario, where the original query is not in the first language, a large language model for the second language and/or a multi-lingual large language model may be used to generate the query response in the second language. In the case that the query is in the first language, a large language model for the first language is used.

In embodiments, the translated query result is used to augment the query to enhance the accuracy of the LLM-generated response. The manner in which the translated query result is passed to the model may vary depending on the LLM. For example, the augmentation data may be concatenated or merged with the query and passed as input to an LLM model. As another example, a query may be augmented by directly including relevant excerpts from documents in a prompt passed to the LLM, or by summarizing the key points and incorporating the summary into the prompt. In some embodiments, the augmentation is passed in the form of a context window, where the retrieved data is added as context (e.g., before a user's query) and passed concurrently to the model. In other embodiments, a multi-step approach may be used, where the generation model processes the augmentation data first and subsequently answers the query using the information. In various embodiments, augmentation data is retrieved from previous queries and/or responses in a conversation. Also, augmentation data is retrieved from documents or document chunks previously included in the conversation or used to generate content for the conversation. For example, a conversation includes queries in a plurality of languages and responses including content originating from documents in a plurality of languages. Augmentation data for a particular query is retrieved based the conversation, or a portion thereof.

The various language models process the inputs, to generate responses that address the query using the instruction results. For example, if the query is written in a second language and/or involves retrieving information from a source in second language, the language model generates a response that offers the information in the second language. In some embodiments, the system generates a plurality of query answer portions based on the ranking of the plurality of query instruction results in a plurality of languages. For example, if the top three results address different aspects of the query, the system integrates these elements to form a comprehensive answer.

In various embodiments, the answer is in a default language (e.g., the first language), or is optionally in another language. For example, if a query requests a response in French and/or documents in French and other languages are identified by the agent core and/or language identification and/or translation model as part of a trajectory for responding to the query, the system produces an answer in French. Even though the answer is in French, the answer is generated using an agent model, which generates thoughts, actions, and/or commands using an English-based agent core and documents in other languages. Thus, the system effectively answers multilinguistic queries.

The system stores the response to the query (Operation 222). This operation involves saving the generated response in a data storage system for future reference or retrieval. In embodiments, the storage utilizes a structured database format to ensure that the response can be easily accessed and indexed. For instance, the response is stored alongside metadata, including timestamps and query, answer, and/or language identifiers for one or more conversations and/or users, facilitating organized retrieval when needed.

The system accesses feedback that is based on the response (Operation 224). In various embodiments, the system gathers feedback through means such as user ratings or comments submitted after the response is delivered. An example of this operation includes accessing a feedback database storing data regarding how users interacted with the response, which can then be utilized to inform future processing or adjustments in the system's behavior during training and/or fine-tuning of models used by the system. In various embodiments, the feedback includes an indication of whether the correct language or languages were identified for the query, whether the query was correctly translated, whether results of executing the query were correctly ranked or reranked, an efficacy score for answers generated by a language model used by the agent system, and/or the like.

The system fine-tunes a language identification model, a language translation model, a linguistic ranking model, and/or a generative language model using the feedback (Operation 226). In various examples, a language identification model is trained based on feedback regarding correct language identification, such as whether an output is in the correct language or uses information based on correctly identifying the language of the information; a language translation model is trained based on feedback regarding accuracy of a corpus of translated language; and/or a language generation model (e.g. a large language model) is trained based on feedback regarding the validity and/or quality of the output of the language generation model. In embodiments, the system utilizes feedback mechanisms or algorithms to refine a linguistic ranking model or other ranking process by which information obtained by executing query instructions is ranked for response generation.

In an embodiment, the system fine-tunes a language identification model by incorporating feedback regarding the correctness of language identification. The system gathers feedback regarding the correctness of one or more languages identified as being associated with the query and/or retrieved documents. In cases where the language identification is correct, the model weights are reinforced. If the system misidentifies a language, model weights are loosened. The process involves repeated iterations in which the system refines the model based on the aggregate feedback from numerous instances.

In embodiments, the system fine-tunes a language translation model using feedback on the accuracy of translations performed during query processing. For example, when a query is submitted in one language, but the RAG agent core performs reasoning in another language, the system translates the query. Feedback on the quality and accuracy of the translated query is used to adjust the model's translation parameters. The system can analyze common errors, such as incorrect grammar or mistranslated idioms, and modify the model to handle these situations more effectively in future translations. Over time, the system improves the translation model's precision.

In embodiments, a linguistic ranking model is fine-tuned through feedback loops that rank the relevance of retrieved document chunks. In an example, the system retrieves and ranks document segments in various languages based on relevance to the query. Feedback on the quality of these rankings, such as whether the most relevant chunks were prioritized, informs adjustments to the model's ranking mechanism. If the feedback indicates that less relevant information was ranked higher than more pertinent content, the system reconfigures its ranking criteria, placing more emphasis on specific linguistic or semantic features. The system iteratively refines the model to increase the effectiveness of document ranking in subsequent queries.

In embodiments, the generative language model used by the system is fine-tuned based on feedback regarding the quality and validity of its outputs. In an example, once the system generates a natural language response based on retrieved data, feedback is provided regarding the fluency, coherence, and factual accuracy of the response. This feedback, obtained from users, automated quality assessment algorithms, and/or other sources, is used to adjust the parameters of the generative model. If the response includes errors or incorrect phrasing, the system identifies areas for improvement, such as refining the understanding of contextual relationships between terms or improving sentence structure. This iterative fine-tuning enhances the generative model's ability to produce more accurate, cohesive, and natural-sounding responses.

FIG. 2B illustrates an example set of operations 251. In FIG. 2B, an agent core accesses a multi-turn conversation having a plurality of queries and answers in the conversation. The plurality of queries and/or the plurality of answers are plurality of languages. In the example, the agent core accesses a conversation (Operation 270). This operation involves accessing data from a live conversation with an automated chat service.

The agent core accesses a pending query (Operation 272). This operation retrieves a query marked as pending within the active conversation. For example, a new query that has not yet been answered is considered as pending.

The agent core determines if an additional language is identified for the pending query (Operation 274). In this example, no additional language is identified for the pending query if the query is in the first language and/or is answerable using a thought, action, observation and/or document in the first language.

If no additional language is identified for the pending query, the agent core generates a response to the pending query using the first language (Operation 276). For example, the agent core uses a natural language generation model trained in the first language to construct a coherent reply that aligns with the user's intent. The agent model also retrieves documents in the first language and/or generates a thought, observation, or action in the first language.

The agent core presents the response in the conversation (Operation 278). This operation incorporates the generated response into the ongoing conversation. For example, the response may be inserted into a text-based chat interface or displayed on a user-facing platform. In embodiments, the system waits until a new pending query is received. Responsive to a new pending query being received, the agent core accesses the query in an operation similar to operation 272.

Responsive to an additional language being identified for the pending query, the agent core provides the query to a model to receive a translated query (Operation 280). For example, this operation includes providing the pending query to a specially trained language translation module, to another model, or an external service to generate an equivalent query in the first language. For instance, a translation algorithm or model converts the query from the original language to the first language using contextual and linguistic data.

The agent core generates instructions in the first language, based on the translated query and the conversation as context (Operation 282). This operation involves transforming the translated query into actionable commands or tasks. The agent core generates a thought, action, or observation based on the pending query and the prior conversation, including prior queries for which an additional language was identified. For example, the system identifies a plurality of languages for a plurality of prior queries and translates the prior queries into the first language to result in a plurality of translated queries. The agent core generates an instruction, thought, action, or observation in the first language based on a plurality of translated prior queries and/or the translated pending query.

The agent core retrieves information from a data source based on the instruction in the first language (Operation 284). For example, the system queries a database to extract relevant information aligned with the conversation context based on the instruction in the first language. In embodiments, the extracted information is in another language and/or is multilingual. Although the instructions are in the first language, the retrieved data includes text in another language.

The agent core generates a response to the pending query based on the retrieved information (Operation 286). For example, the agent core provides the translated pending query and the information retrieved information to a generative language model to cause the model to generate an output. The agent core accesses the output generated by the generative language model and incorporates the output as the response to the pending query.

The agent core transmits the response to the pending query (Operation 288). This operation delivers the generated response to the conversation interface, marking the query as processed. In an embodiment, the response is displayed to the user, and the pending query is resolved. If a new pending query is received, the agent core accesses the new pending query in an operation similar to Operation 272.

### 4. Example Multilinguistic Agent Response

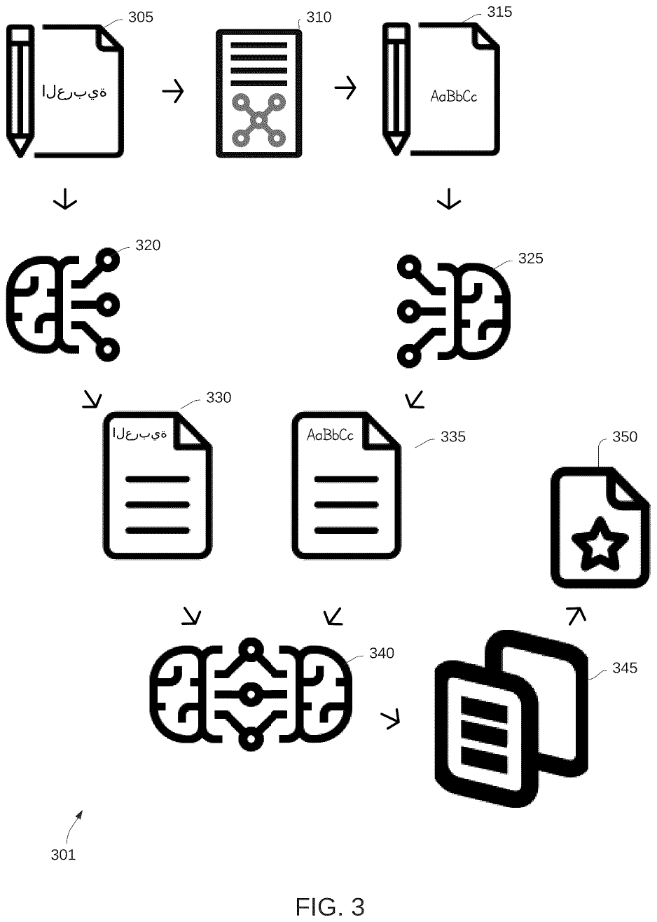

FIG. 3 illustrates an example 301 of multilinguistic query response by a multilinguistic agent response system, such as the multilinguistic agent response system 100 of FIG. 1 or a similar system. In FIG. 3, the multilinguistic agent response system accesses a query 305. The query 305 includes content in one or more second languages and/or includes a portion of the query that a language identification service and/or an agent core determines requires a source, instruction, or operation in a second language to answer. In the example, the query 305 contains text segments written in the second language that involve complex instructions in the second language or retrieval of documents in the second language.

The query 305 is processed through a language identification and/or translation model 310, which analyzes the content to determine the language or languages of the query. For example, a language identification model identifies a plurality of different languages because the example query includes instructions that request documents in one or more second languages or that use language models for one or more second languages different from a first language. The language identification and/or translation model 310 translates these portions of the query 305 that are in the second language into the first language using trained linguistic algorithms to generate a translated query 315.

The language identification model of some embodiments identifies languages for documents to be retrieved during a query response. For instance, a technical document in a second language is referenced by a query, or a model having the second language as a primary language of the model (i.e., the model translates input to a primary language and/or answers by default in a primary language other than the first language) is included in a trajectory of instructions generated by an agent core of the system.

The language identification and/or translation model 310 outputs the translated query 315. The translated query 315 is translated to the first language but retains the meaning and context of the query 305 in the second language. In some embodiments, a translation model is trained and/or fine-tuned using labeled sets of translated texts that have been manually and/or computer generated and used as training data.

The system provides the query 305 as an input to a language model 320. The language model 320 processes the query 305. The language model 320 accepts instruction in the second language as input and is capable of understanding and interpreting complex instructions or concepts present in the query 305. The language model 320 processes the query 305. In the example, the system retrieves one or more documents in the second language (such as by searching a knowledge base for the second language) or performs another operation based on instructions in the second language.

The system inputs the translated query 315, which is now in the first language, into a language model 325. The language model 325 accepts instruction in first language as input and is capable of understanding and interpreting complex instructions or concepts present in the query 315. The language model 325 processes the query 315. In the example, the language model 325 processes the query by retrieving a document 335 in the first language or following another instruction in the first language.

The document 330 and/or the document 335 are provided as input documents to one or more large language models 340 along with some or all of the initial and/or translated query. The large language models generates one or more answer portions 345 based on the input document(s).

The agent system aggregates the answer portions 345 into an answer 350. The answer 350 answers the query 305. In embodiments, the answer 350 is accessible via a user device connected to the agent system via an interface. The agent system generates the answer 350 by aggregating, ranking, and/or reranking answers and/or portions of answers. The answers and/or portions of answers are ranked based on language accuracy, content accuracy, alignment, and/or other criteria. The answer 350 includes the most contextually accurate response to the query based on executing instructions associated with the query generated by translating the query from the second language to the first language and generating agent trajectories in the second language. In embodiments, the answer 350 integrates information from both model 320 and model 325, facilitating a response to the query 305 and use of knowledge bases and/or tools that are not available in a second language of the query 305. By translating the query 305 and recombining the results from language models for the query and one or more translated queries, the answers generated by the system are improved.

In embodiments, the answer is generated in a language that is based on a query. For example, an answer is generated in a second language based on the query being in the second language. Subsequent answers are generated in one or more additional languages responsive to a query being received for the one or more additional languages in the conversation.

In embodiments, the agent system accesses feedback for one or more answers. In embodiments, the feedback is direct feedback (i.e., a feedback score or positive or negative feedback) and/or feedback that is generated based on other attributes of subsequent input from a user or client device. The feedback is included with the query and answer and used as training data to improve one or more models used by the system. For example, an agent core, a retrieval module, and/or a reranking module are fine-tuned using feedback as training data.

### 5. Machine Learning Architecture

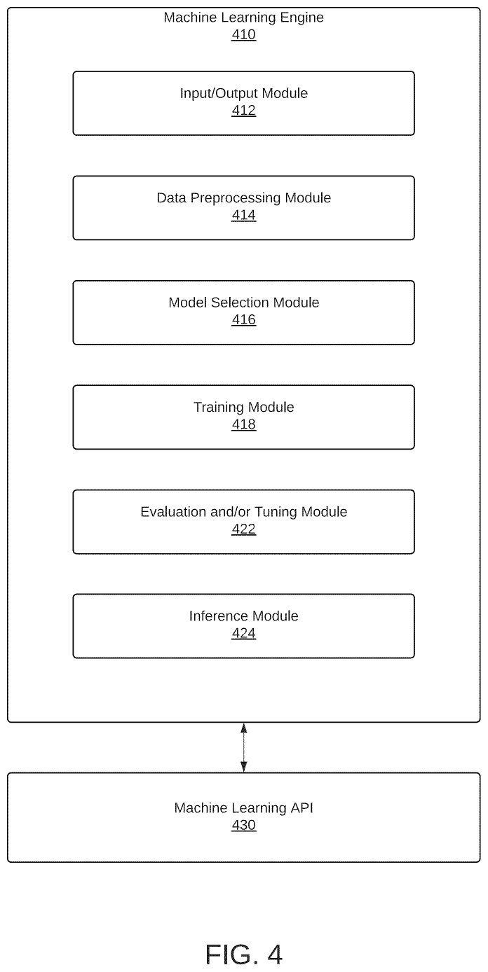

FIG. 4 illustrates a machine learning engine 400 in accordance with one or more embodiments. As illustrated in FIG. 4, machine learning engine 400 includes input/output module 420, data preprocessing module 422, model selection module 424, training module 426, evaluation and tuning module 428, and inference module 430.

In accordance with an embodiment, input/output module 420 serves as the primary interface for data entering and exiting the system, managing the flow and integrity of data. This module may accommodate a wide range of data sources and formats to facilitate integration and communication within the machine learning architecture.

In an embodiment, an input handler within input/output module 420 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 420 to be versatile in different operational contexts, whether processing historical datasets or streaming data.

In accordance with an embodiment, input/output module 420 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 420 includes an output framework designed to handle the distribution and exportation of outputs, predictions, or insights. Using the output framework, input/output module 420 formats these outputs into user-friendly and accessible formats, such as reports, visualizations, or data files compatible with other systems. Input/output module 420 also ensures secure and efficient transmission of these outputs to end-users or other systems in an embodiment and may employ encryption and secure data transfer protocols to maintain data confidentiality.

In accordance with an embodiment, data preprocessing module 422 transforms data into a format suitable for use by other modules in machine learning engine 400. For example, data preprocessing module 422 may transform raw data into a normalized or standardized format suitable for training ML models and for processing new data inputs for inference. In an embodiment, data preprocessing module 422 acts as a bridge between the raw data sources and the analytical capabilities of machine learning engine 400.

In an embodiment, data preprocessing module 422 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 422 may be configured to handle anomalies in different ways depending on context. Data preprocessing module 422 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 422 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 422 processes new data for inference, data preprocessing module 422 replicates the same preprocessing steps to ensure consistency with the training data format. This helps to avoid discrepancies between the training data format and the inference data format, thereby reducing the likelihood of inaccurate or invalid model predictions.

In an embodiment, model selection module 424 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 424 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 424 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 424 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 424 also considers computational efficiency and resource constraints. This is meant to help ensure the selected model is both accurate and practical in terms of computational and time requirements. In an embodiment, certain features of model selection module 424 are configurable such as a configured bias toward (or against) computational efficiency.

In accordance with an embodiment, training module 426 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 426 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 426 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 426 includes logic to handle different types of data and learning tasks. For instance, it includes different training routines for supervised learning (where the training data comes with labels) and unsupervised learning (without labeled data). In the case of deep learning models, training module 426 also manages the complexities of training neural networks that include initializing network weights, choosing activation functions, and setting up neural network layers.

In an embodiment, evaluation and tuning module 428 incorporates dynamic feedback mechanisms and facilitates continuous model evolution to help ensure the system's relevance and accuracy as the data landscape changes. Evaluation and tuning module 428 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 428 performs continuous model tuning by using hyperparameter optimization. Evaluation and tuning module 428 performs an exploration of the hyperparameter space using algorithms, such as grid search, random search, or more sophisticated methods like Bayesian optimization. Evaluation and tuning module 428 uses these algorithms to iteratively adjust and refine the model's hyperparameters - settings that govern the model's learning process but are not directly learned from the data - to enhance the model's performance. This tuning process helps to balance the model's complexity with its ability to generalize and attempts to avoid the pitfalls of underfitting or overfitting.

In an embodiment, evaluation and tuning module 428 integrates data feedback and updates the model. Evaluation and tuning module 428 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 428 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 428 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 430 transforms data raw data into actionable, precise, and contextually relevant predictions. In addition to processing and applying a trained model to new data, inference module 430 may also include post-processing logic that refines the raw outputs of the model into meaningful insights.

In an embodiment, inference module 430 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 430 transforms the outputs of a trained model into definitive classifications. Inference module 430 employs the underlying model as a tool to generate probabilistic outputs for each potential class. It then engages in an interpretative process to convert these probabilities into concrete class labels.

In an embodiment, when inference module 430 receives the probabilistic outputs from the model, it analyzes these probabilities to determine how they are distributed across some or every potential class. If the highest probability is not significantly greater than the others, inference module 430 may determine that there is ambiguity or interpret this as a lack of confidence displayed by the model.

In an embodiment, inference module 430 uses thresholding techniques for applications where making a definitive decision based on the highest probability might not suffice due to the critical nature of the decision. In such cases, inference module 430 assesses if the highest probability surpasses a certain confidence threshold that is predetermined based on the specific requirements of the application. If the probabilities do not meet this threshold, inference module 430 may flag the result as uncertain or defer the decision to a human expert. Inference module 430 dynamically adjusts the decision thresholds based on the sensitivity and specificity requirements of the application, subject to calibration for balancing the trade-offs between false positives and false negatives.

In accordance with an embodiment, inference module 430 contextualizes the probability distribution against the backdrop of the specific application. This involves a comparative analysis, especially in instances where multiple classes have similar probability scores, to deduce the most plausible classification. In an embodiment, inference module 430 may incorporate additional decision-making rules or contextual information to guide this analysis, ensuring that the classification aligns with the practical and contextual nuances of the application.

In regression models, where the outputs are continuous values, inference module 430 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 430 incorporates domain-specific adjustments into its post-processing routine. This involves tailoring the model's output to align with specific industry knowledge or contextual information. For example, in financial forecasting, inference module 430 may adjust predictions based on current market trends, economic indicators, or recent significant events, ensuring that the outputs are both statistically accurate and practically relevant.

In an embodiment, inference module 430 includes logic to handle uncertainty and ambiguity in the model's predictions. In cases where inference module 430 outputs a measure of uncertainty, such as in Bayesian inference models, inference module 430 interprets these uncertainty measures by converting probabilistic distributions or confidence intervals into a format that can be easily understood and acted upon. This provides users with both a prediction and an insight into the confidence level of that prediction. In an embodiment, inference module 430 includes mechanisms for involving human oversight or integrating the instance into a feedback loop for subsequent analysis and model refinement.

In an embodiment, inference module 430 formats the final predictions for end-user consumption. Predictions are converted into visualizations, user-friendly reports, or interactive interfaces. In some systems, like recommendation engines, inference module 430 also integrates feedback mechanisms, where user responses to the predictions are used to continually refine and improve the model, creating a dynamic, self-improving system.

### 6. Machine Learning Operations

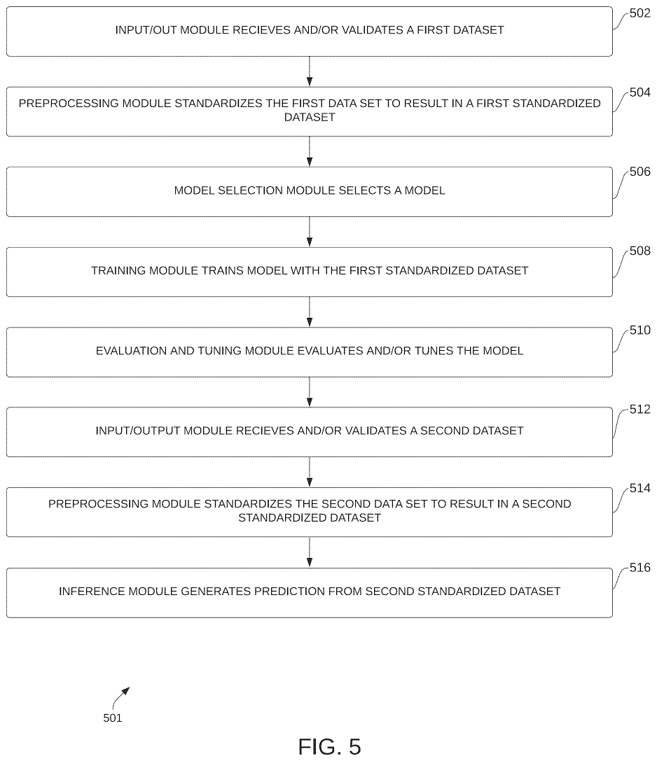

FIG. 5 illustrates a set of machine learning operations 500. In embodiments, one or more operations of the set of operations 500 is performed by a machine learning engine such as machine learning engine 400. In an embodiment, input/output module 420 receives a dataset intended for training (Operation 502). This data can originate from diverse sources, like databases or real-time data streams, and in varied formats, such as CSV, JSON, or XML. Input/output module 420 assesses and validates the data, ensuring its integrity by checking for consistency, data ranges, and types.

In an embodiment, training data is passed to data preprocessing module 422. Here, the data undergoes a series of transformations to standardize and clean it, making it suitable for training ML models (Operation 504). This involves normalizing numerical data, encoding categorical variables, and handling missing values through techniques like imputation.

In an embodiment, prepared data from the data preprocessing module 422 is then fed into model selection module 424 (Operation 506). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 426 trains the selected model with the prepared dataset (Operation 508). It implements learning algorithms to adjust the model's internal parameters, optimizing them to identify patterns and relationships in the training data. Training module 426 also addresses the challenge of overfitting by implementing techniques, like regularization and early stopping, ensuring the model's generalizability.

In an embodiment, evaluation and tuning module 428 evaluates the trained model's performance using the validation dataset (Operation 510). Evaluation and tuning module 428 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 420 receives a dataset intended for inference. Input/output module 420 assesses and validates the data (Operation 512).

In an embodiment, data preprocessing module 422 receives the validated dataset intended for inference (Operation 514). Data preprocessing module 422 ensures that the data format used in training is replicated for the new inference data, maintaining consistency and accuracy for the model's predictions.

In an embodiment, inference module 430 processes the new data set intended for inference, using the trained and tuned model (Operation 516). It applies the model to this data, generating raw probabilistic outputs for predictions. Inference module 430 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 440 allows for applications to leverage machine learning engine 400. In an embodiment, machine learning engine API 440 may be built on a RESTful architecture and offer stateless interactions over standard HTTP/HTTPS protocols. Machine learning engine API 440 may feature a variety of endpoints, each tailored to a specific function within machine learning engine 400. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 440 is equipped to support SOAP-based interactions. This extension involves defining a WSDL (Web Services Description Language) document that outlines the API's operations and the structure of request and response messages. In an embodiment, machine learning engine API 440 supports various data formats and communication styles. In an embodiment, machine learning engine API 440 endpoints may handle requests in JSON format or any other suitable format. For example, machine learning engine API 440 may process XML, and it may also be engineered to handle more compact and efficient data formats, such as Protocol Buffers or Avro, for use in bandwidth-limited scenarios.

In an embodiment, machine learning engine API 440 is designed to integrate WebSocket technology for applications necessitating real-time data processing and immediate feedback. This integration enables a continuous, bi-directional communication channel for a dynamic and interactive data exchange between the application and machine learning engine 400.

### 7. Generative Artificial Intelligence Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a “SoftMax” function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 120, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 122 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 416, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 126, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 128 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 130, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 8. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (“NAT”). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a taxonomic negative sampling-based machine learning system via a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment versions of a taxonomic negative sampling-based machine learning system may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 9. Microservice Applications

According to one or more embodiments, the techniques described herein are implemented in a microservice architecture. A microservice in this context refers to software logic designed to be independently deployable, having endpoints that may be logically coupled to other microservices to build a variety of applications, for example, by logically coupling a taxonomic negative sampling-based machine learning system to a software logic endpoint. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, or other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 10. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

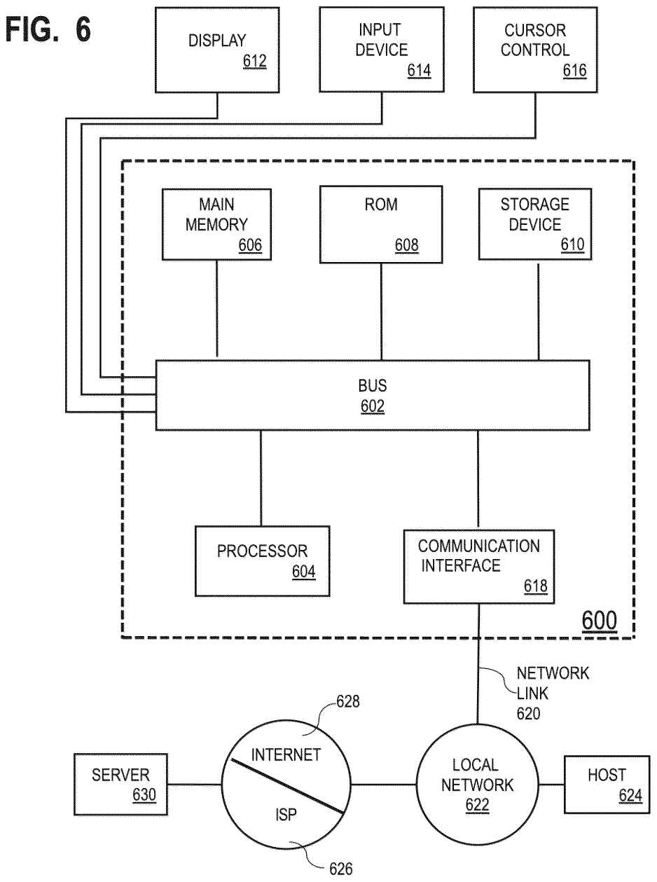

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 11. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method, comprising:
accessing a first query;
responsive to determining that the first query is in a first language that is different than a target language:
generating a translated query by translating the first query from the first language to the target language;
generating a first command based on the translated query by providing the translated query to a first model configured for the target language and receiving the first command as output from the first model;
generating a first response in the first language using a second model by providing the first query and an input based on the first command to the second model; and
storing the first response;
wherein the method is performed by at least one device including a hardware processor.

2. The method of claim 1, wherein:
the second model is a language model configured for the first language;
the method further comprising:
responsive to determining that the language of the first query is the target language:
generating a second command based on the first query by providing the first query to the first model;
generating a second response in the target language by providing the first query and an input based on the second command to a third model, the third model being a language model configured for the target language; and
storing the second response.

3. The method of claim 1, wherein:
the first command comprises an identification of information including first language information in the first language and second language information in the target language, the method further comprising:
ranking the first language information and the second language information, and
generating the first response based on the ranking.

4. The method of claim 3, wherein:
ranking the first language information and the second language information comprises:
ranking the first language information with a first ranking method configured for the first language; and
ranking the second language information with a second ranking method configured for the second language.

5. The method of claim 1, wherein:
the first command comprises a command in the target language to access information from a data source; and
generating the first response comprises providing the first query and the information as context with the first query as input into to the second model.

6. The method of claim 1, further comprising:
using a language detection model to determine the language of the first query.

7. The method of claim 1, further comprising:
accessing an identification of a selected language, wherein the second model is configured for the selected language.

8. The method of claim 1, further comprising:
determining a language of the first query using a specialized language determination model;
wherein said generating the translated query is performed using the language determination model; and
wherein the specialized language determination model executes operations on one or more central processing units.

9. The method of claim 8, further comprising:
receiving feedback for the first response; and
fine-tuning the specialized language determination model using the feedback.

10. The method of claim 1, wherein:
the first model is an agent model comprising a thought, action, observation framework.

11. The method of claim 1, wherein:
the first model comprises a thought language model (LM), an action LM, and an observation LM;
the thought LM has a first number of parameters;
the action LM has a second number of parameters;
the observation LM has a third number of parameters; and
the second model has a fourth number of parameters that is greater than the first number, the second number, and the third number.

12. The method of claim 11, wherein:
the thought LM has less than seven billion (7 B) parameters, the action LM has less than seven billion (7 B) parameters, and the observation LM has less than seven billion (7 B) parameters.

13. The method of claim 1, wherein:
the second model is a language model configured to provide output in the first language;
prior to generating the translated query, the first model accesses a determination of whether to generate a response to the first query using (a) a language model configured to provide output in the target language or (b) a language model configured to provide output in the first language; and
the steps of generating the translated query, generating the first command, and generating the first response using the second model are performed responsive to determining to generate a response to the first query using a language model configured to provide output in the first language.

14. The method of claim 1, wherein:
a number of parameters for the second model is at least one hundred billion (100 B) parameters.

15. The method of claim 1, wherein:
the first model is a first agent model associated with the target language, the method comprising:
responsive to determining that the language of the first query is a second language different from the first language and the target language, providing the first query to a second agent model, the second agent model being configured for the second language.

16. The method of claim 1, wherein:
the first model has at least one order of magnitude less parameters than the second model.

17. One or more non-transitory computer readable media comprising:
instructions which, when executed by one or more hardware processors, cause performance of operations comprising:
accessing a first query;
responsive to determining that the first query is in a first language that is different than a target language:
generating a translated query by translating the first query from the first language to the target language;
generating a first command based on the translated query by providing the translated query to a first model configured for the target language and receiving the first command as output from the first model;
generating a first response in the first language using a second model by providing the first query and an input based on the first command to the second model; and
storing the first response.

18. The computer readable media of claim 17, wherein:
the second model is a language model configured for the first language;
the method further comprising:
responsive to determining that the language of the first query is the target language:
generating a second command based on the first query by providing the first query to the first model;
generating a second response in the target language by providing the first query and an input based on the second command to a third model, the third model being a language model configured for the target language; and
storing the second response.

19. A system comprising:
at least one device including a hardware processor;
the system being configured to perform operations comprising:
accessing a first query;
responsive to determining that the first query is in a first language that is different than a target language:
generating a translated query by translating the first query from the first language to the target language;
generating a first command based on the translated query by providing the translated query to a first model configured for the target language and receiving the first command as output from the first model;
generating a first response in the first language using a second model by providing the first query and an input based on the first command to the second model; and
storing the first response.

20. The system of claim 19, wherein:
the second model is a language model configured for the first language;
the method further comprising:
responsive to determining that the language of the first query is the target language:
generating a second command based on the first query by providing the first query to the first model;
generating a second response in the target language by providing the first query and an input based on the second command to a third model, the third model being a language model configured for the target language; and
storing the second response.
